(19) United States
(12) Patent Application Publication
(10) Pub. No.: US 2023/0094961 A1
(43) Pub. Date: Mar. 30, 2023

(54) DYNAMIC GROWTH MODEL CONSTRUCTION METHOD AND SYSTEM FOR CROP CANOPY STRUCTURE, AND STORABLE MEDIUM

(71) Applicant: China Institute of Water Resources and Hydropower Research, Beijing (CN)

(72) Inventors: Baozhong ZHANG, Beijing (CN); Meng DUAN, Beijing (CN); Zheng WEI, Beijing (CN); Congying HAN, Beijing (CN); Yaqi WANG, Beijing (CN); Zhi ZHAO, Beijing (CN); Jiabing CAI, Beijing (CN); Zhigong PENG, Beijing (CN); He CHEN, Beijing (CN); Shuaijie ZHANG, Beijing (CN)

(73) Assignee: China Institute of Water Resources and Hydropower Research, Beijing (CN)

(21) Appl. No.: 17/841,718

(22) Filed: Jun. 16, 2022

(30) Foreign Application Priority Data
Sep. 16, 2021 (CN) 202111088757.7

(51) Int. Cl. G06F 30/20; G06F 30/13; G06Q 50/02

(52) U.S. Cl. CPC G06F 30/20; G06F 30/13; G06Q 50/02; G06F 2111/10

(57) ABSTRACT

Through exploration of the characteristics of a crop canopy structure and the variation laws in the crop development processes, a three-dimensional crop canopy structure model and a dynamic maize growth simulation are established by fusing the three-dimensional crop canopy structure model. The model describes the crop growth and development stages by adopting growing degree-days, carries out dynamic simulation on a two-dimensional maize canopy structure by adopting a Logistic equation, and characterizes veins, leaf margin and the like by adopting a spatial topological structure. On this basis, a dynamic simulation method for a three-dimensional spatial crop canopy structure is finally established, the coupling simulation of multiple hydrothermal carbonization processes in a complex farmland ecosystem is realized, and thus the simulation capability and universality of the crop model are effectively improved.

### CROSS REFERENCE TO THE RELATED APPLICATIONS

This application is based upon and claims priority to Chinese Patent Application No. 202111088757.7, filed on Sep. 16, 2021, the entire contents of which are incorporated herein by reference

### TECHNICAL FIELD

The present invention relates to the technical field of plant growth analysis, and in particular to a dynamic growth model construction method and system for a crop canopy structure, and a storable medium.

### BACKGROUND

The crop model quantitatively describes the complex interaction relationship of elements such as meteorological factors, soil moisture, nutrients and temperature in the crop ecosystem in the processes of crop growth, development and the like by the description of the characteristics of all components in the farmland ecosystem and the influence of the components on the system, and provides an important means for optimizing cultivation, reasonable moisture supply, reasonable resource utilization, planting benefit optimization and the like. In recent years, with the development of computer technology and the continuous improvement of computer performance, scholars at home and abroad have made great progress in the research and application of crop models.

Currently, at least 250 crop simulation models have been developed based on incomplete statistics. According to the development characteristics of the crop models, the crop models can be divided into the following categories: category one is a mechanism model, such as a computer model of maize photosynthetic production constructed by de Wit, a Dutch scholar, a model of influence of maize leaf area and leaf blade angle on group photosynthesis developed by Duncan et al., an ELCROS (Elementary Crop Simulator) model established by the school of de Wit based on system dynamics as a theoretical basis, and a C3 plant photosynthetic biochemical model (referred to as FvCB model for short) provided by Farquhar et al., and a C4 plant photosynthetic model established by colatz et al., which can simulate photosynthetic biochemical reactions inside leaf blades; category two is an empirical model, in order to improve the applicability of the crop model, the crop mechanism model is connected with multidisciplinary, the complex crop model is subjected to parameter simplification, such as a CERES-Maize model and a GROPGRO-Soybean model, the connection is established between a crop growth model and a geographic information system ArcView, and the spatial-temporal change of soybeans and maize on the field scale can be simulated; the United States WGEN and the United Kingdom LARS-WG establish the combination of a stochastic weather generator and a crop model so as to form an agricultural production decision system; the Lobell team in the United States proposed an SCYM (Scalable Crop Yield Mapper) framework that couples multispectral satellite remote sensing data to crop growth estimates; and category three is a comprehensive model, which can not only simulate the growth, the development, the dry matter, the yield and the like of crops, but also simulate the habitat conditions of the crops, and there are early models, for example, the BACROS model (basic crop simulation) and the SUCROS (simple and universal crop simulator) model developed by the team from Wageningen University & Research in the Netherlands on the basis of the ELCROS model; the SUCROS model is based on the simulation of the photosynthesis of the crop canopies, and can be applied to different environmental conditions and different crop species only by changing the crop parameters. Currently, the comprehensive models widely used include a WOFOST (World Food Studies) model developed by Hijmans, an APSIM (Agricultural Production Systems slMulator) model developed by CSIRO of Australia, a DSSAT (Decision Support System for Agrotechnology Transer) model developed by University of Hawaii, an AquaCrop model developed by the Food and Agriculture Organization of the United Nations, and the like. However, most of the current crop models are one-dimensional vertical models of a soil-crop-atmosphere system, and characterize the conditions of crop canopies by mainly adopting parameters such as leaf area indexes and canopy coverage. Due to insufficient attention on the characteristics of crop canopy structure, the simulation error of the hydrothermal carbonization processes inside the system is large and the universality of the model is insufficient, and particularly the existing crop models generate remarkable deviation due to remarkably change of the canopy structure caused by the adjusted planting mode.

Although some scholars implement the expansion of the crop model in the regional scale by means of the GIS technology, the model is actually “pseudo-three-dimensional”, because this model cannot solve the problem of uneven distribution of components in the spatial ecosystem, for example, the problem of competition of different crop growth (including illumination, moisture, nutrients, land resources and the like) and horizontal migration of substances (including moisture, nutrients, pesticides and the like) on the region. Therefore, the establishment of a three-dimensional spatial crop growth simulation system is an important direction for breaking through the one-dimensional spatial limitation of a crop model and expanding the crop model to a region, and is a basis for the application of the model expanding to the regional scale.

With respect to the limitations of one-dimensional models, numerous scholars have attempted to characterize the canopy structures. Greyson et al. studied the relationship between leaf blade width and leaf position; Hesketh et al. established the relationship between leaf blades, leaf sheaths and internodes; Girardin et al. studied the azimuth angle distribution law of leaf blade of maize and the like. Although many scholars have established models of spatial crop structures, these models are mostly static simulations, and thus have not been coupled with dynamic crop growth models. Researches find that the crop canopy structure finally causes different photosynthetic yields by influencing the light interception quantity inside the canopy, and the photosynthetic yields influence the development and morphogenesis of each organ of a plant and finally cause the change of the canopy structure. Therefore, a crop model is urgently needed to fully reflect the complex physiological and ecological change process.

### SUMMARY

In view of this, the present invention provides a dynamic growth model construction method and system for a crop canopy structure, and a storable medium. Through full research of the characteristics of a crop canopy structure (canopy type, leaf type, spike type, internode, leaf sheath and the like) and the variation laws in the crop development processes, the present invention establishes a three-dimensional crop canopy structure model, establishes a dynamic maize growth simulation by fusing the three-dimensional crop canopy structure model, and finally establishes a characteristic platform of a phenotype structure of a three-dimensional spatial crop canopy structure, thus realizing dynamic simulation of a water-carbon process of a soil-crop-atmospheric system, and effectively improving the simulation capability and universality of the crop model.

In order to achieve the above objective, the present invention adopts the following technical solutions:

Provided is a dynamic crop growth model construction method for a three-dimensional canopy structure, comprising the following steps:
acquiring crop parameters;
establishing a two-dimensional crop canopy structure simulation model according to the crop parameters; and
constructing a three-dimensional dynamic crop growth simulation model by utilizing the two-dimensional crop canopy structure model and spatial change characteristics of each organ of crops.

Optionally, the method further comprises establishing a dynamic model of a water-carbon process of a soil-crop-atmospheric system according to the three-dimensional dynamic crop growth model, specifically as follows:

On the basis of quantifying a three-dimensional dynamic single-plant growth simulation model, constructing a deduction method for crop leaf blades to a single plant canopy and then to a spatial canopy structure of a crop group, constructing a database based on data, realizing topological expansion of the spatial structure, and meanwhile, integrating a time dimension, and constructing a crop water-carbon flux multi-spatial-temporal cooperative coupling quantitative characterization method.

Optionally, the crop parameters comprise canopy structure characteristics and variation laws in crop development processes; the canopy structure characteristics comprise: a canopy type, a leaf type, a spike type, an internode, and a leaf sheath.

Optionally, the two-dimensional canopy structure model describes crop growth and development stages by adopting growing degree-days, and carries out dynamic simulation on a two-dimensional crop canopy structure by adopting a Logistic equation.

Optionally, the step of constructing a three-dimensional dynamic crop growth simulation model specifically comprises the following steps: on the basis of the two-dimensional canopy structure simulation model, characterizing veins and leaf margins by adopting a spatial topological structure, and constructing a three-dimensional dynamic growth simulation model.

Provided is a dynamic crop growth model construction system for a three-dimensional canopy structure, comprising:
a crop parameter acquisition module, used for acquiring crop parameters;
a two-dimensional crop canopy structure model establishment module, used for establishing a two-dimensional crop canopy structure simulation model according to the crop parameters; and
a three-dimensional dynamic crop growth simulation construction module, used for constructing a three-dimensional dynamic crop growth simulation model by fusing the two-dimensional crop canopy structure model.

Optionally, the system further comprises a dynamic model establishment module of a water-carbon process of a soil-crop-atmospheric system used for establishing a dynamic model of a water-carbon process of a soil-crop-atmospheric system according to the three-dimensional dynamic crop growth model.

Provided is a computer storage medium having a computer program stored thereon, wherein the computer program, when being executed by a processor, implements the steps of the dynamic crop growth model construction method for a three-dimensional canopy structure.

According to the above-mentioned technical solutions, compared with the prior art, the dynamic crop growth model construction method and system and the storable medium disclosed herein solve the problem that the deviation is generated due to the fact that the existing crop models characterize the crop canopy conditions by only adopting parameters such as leaf area indexes and canopy coverage, and particularly the precision of the crop growth simulation is greatly improved after the canopy structure is remarkably changed due to the adjusted planting mode, and the universality of the crop model is greatly improved. In addition, the present invention provides a novel means for quantitative precision agriculture in the future, and has a wide prospect for understanding the interrelation among all components of a farmland ecosystem, improving the utilization efficiency of agricultural irrigation water and realizing the expansion and application of a model on a regional scale.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are some embodiments of the present invention, and those of ordinary skilled in the art can obtain other drawings according to the drawings provided herein without creative efforts.

FIG. 1 is a dynamic simulation framework diagram of a two-dimensional spatial crop structure according to the present invention; and

FIG. 2 is a dynamical simulation framework diagram of a three-dimensional spatial crop structure according to the present invention.

### DETAILED DESCRIPTION OF THE EMBODIMENTS

The technical solutions in the embodiments of the present invention will be clearly and completely described below with reference to the drawings in the embodiments of the present invention, and it is obvious that the described embodiments are only a part of the embodiments of the present invention but not all of them. Based on the embodiments of the present invention, all other embodiments obtained by those of ordinary skilled in the art without creative efforts fall within the protection scope of the present invention.

An embodiment of the present invention discloses a dynamic crop growth model construction method for a three-dimensional canopy structure, which comprises the following steps:
acquiring crop parameters;
establishing a two-dimensional crop canopy structure simulation model according to the crop parameters; and
constructing a three-dimensional dynamic crop growth simulation model by utilizing the two-dimensional crop canopy structure model and spatial change characteristics of each organ of crops.

The method further comprises establishing a dynamic model of a water-carbon process of a soil-crop-atmospheric system according to the three-dimensional dynamic crop growth model, specifically as follows:

On the basis of quantifying a three-dimensional dynamic single-plant growth simulation model, constructing a deduction method for crop leaf blades to a single plant canopy and then to a spatial canopy structure of a crop group, constructing a database based on data, realizing topological expansion of the spatial structure, and meanwhile, integrating a time dimension, and constructing a crop water-carbon flux multi-spatial-temporal cooperative coupling quantitative characterization method.

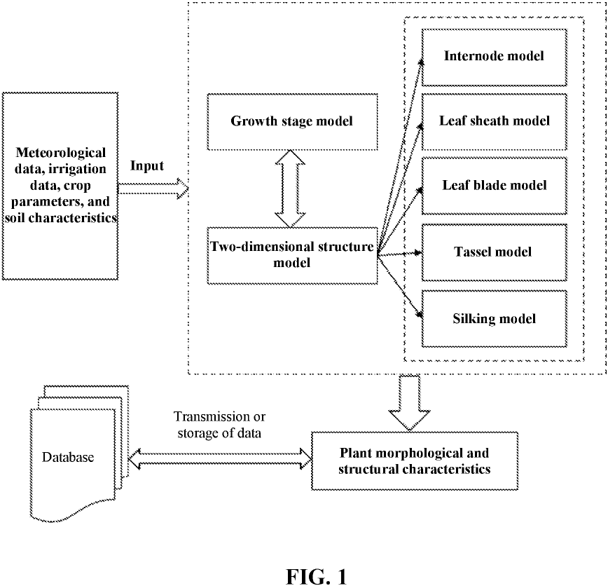

Specifically, the method is as follows:
Provided is a two-dimensional maize canopy structure simulation model, as shown in FIG. 1:
Simulation of maize growth stage
Simulation of growing degree-days (GDDs)

The crop model usually describes crop growth and development stages by adopting growing degree-days (GDDs), and if T_{MAX} and T_{MIN} meet the following conditions, then a calculation formula of GDD is as follows:

$$G D D = \left\{\begin{matrix}0 \left({T}_{M A X} < {T}_{b}\right) \\ {T}_{0} - {T}_{b} \left({T}_{o} < {T}_{M I N}\right) \\ \left({T}_{M A X} + {T}_{M I N}\right) / 2 - {T}_{b} \left({T}_{b} \leq {T}_{M A X} , {T}_{M I N} \leq {T}_{0}\right)\end{matrix}\right)$$

wherein Tₒ is an optimum temperature for maize growth, T_{b} is a base temperature for maize growth, and T_{MAX} and T_{MIN} are a daily maximum temperature and a daily minimum temperature, respectively.

If the daily maximum temperature and the daily minimum temperature do not meet the above-mentioned conditions, then the influence of the day-night temperature difference on the development of crops shall be considered. This means that the influence of the day-night temperature difference on the crops needs to be considered. The following equations can be used:

$$T f a c \left(i\right) = sin \left(3.14 / 12 ∗ i\right) / 2$$

$$T \left(i\right) = \left({T}_{M A X} + {T}_{M I N}\right) / 2 + T f a c \left(i\right) ∗ \left({T}_{M A X} - {T}_{M I N}\right)$$

$$T \left(i\right) = \left\{\begin{matrix}{T}_{b} \left(T \left(i\right) \leq {T}_{b} , T \left(i\right) > {T}_{m}\right) \\ {T}_{0} \left({T}_{0} \leq T \left(i\right) \leq {T}_{m}\right) \\ T \left(i\right) \left({T}_{b} \leq T \left(i\right) \leq {T}_{0}\right)\end{matrix}\right)$$

$$G D D = \sum \left(T \left(i\right) - {T}_{b}\right) / 24$$

$$S U M G D D = \sum G D D$$

wherein Tfac(i) (i = 1, 2, 3,......24) is a temperature change factor of each period, T(i) is a temperature of each period, Tₘ is a maximum temperature of the crop growth period, and SUMGDD is a sum of GDDs of each development period.

### Simulation of Maize Development Stage

The maize development period is divided into 7 stages according to the genetic characteristics and environmental factors of maize. Quantitative development of thermal effect, photoperiod effect and genetic effect is considered, and a unified physiological development time scale is established. The maize development period is as follows:
S1 (sowing to seedling emergence). The GDD at this stage is mainly influenced by the thermal effect of the soil. GDD1 is obtained by the calculation of cumulative growing degree-days, and can be expressed as follows:
$$G D D 1 = 45 + D T T E * S D E P T H$$
wherein DTTE is cumulative growth days required per soil layer depth at the time of seedling emergence, and SDEPTH is a maize sowing depth. In the model simulation process, when SUMGDD ≥ GDD1, the next growth stage is started.
S2 (seedling stage). S2 is the stage from seedling emergence to the end of the seedling stage, and GDD is obtained by the calculation of P1 (see FIG. 1).
S3 (end of seedling stage to start of jointing stage). The stage S3 is mainly influenced by the day length, which is determined by the total photoperiod induction rate. The calculation formulas are as follows:
$$R A T E I N = \left\{\begin{matrix}1 / \left(D J T 1 + P 2 * \left(D L E N - P 20\right)\right) D L E N > P 20 \\ 1 / D J T 1 D L E N \leq P 20\end{matrix}\right)$$
$$S I N D = \sum R A T E I N$$
wherein DLEN is actual sunshine hours [h], P20 is critical maize sunshine hours, and P2 is an hourly increase in the number of days when the sunshine hours exceed the critical daylength. DJTI is minimum growth-period days required to be unaffected by the photoperiod. SIND is a cumulative photoperiod induction rate at this stage, and when its value is 1, the growth phase ends.
S4 (jointing stage). S4 is the stage from the start of the jointing stage to the start of the tasseling stage, and can be expressed as follows:
$$T L N O = C U M D T T / \left(P H I N T * 0.5\right) + 5$$
$$P 3 = ( ( T L N O + 0.5 ) ∗ P H I N T ) - C U M D T T$$
wherein TLNO is a total number of leaf blades, CUMDTT is cumulative growing degree-days of S2 and S3 stages, PHINT is a leaf emergence interval of the leaf blades, and P3 is the GDD at stage 4.
S5 (tasseling stage). S5 is the stage from the start of the tasseling stage to an effective grain filling stage, and the cumulative growth stage is calculated from DSGFT (see Table 1).
S6 (grain filling stage). S6 is the effective grain filling stage which is mainly influenced by temperature, and can be expressed as follows:
$$S U M D T T \geq P 5 ∗ 0.95$$
wherein SUMDTT is the cumulative photoperiod induction at this stage. This stage ends when the above-mentioned formula is valid. P5 is the GDD at stage 6.

The simulation of the entire maize development stage ends when the cumulative GDDs reach P5 at stages 5, 6 and 7. S7 is the maize mature stage. The parameters of the maize development period are shown in Table 1.

TABLE 1

Maize growth and development stage parameters and values

| Symbol | Description | Value range | Value | Unit |
|---|---|---|---|---|
| T_{b} | Base temperature for maize growth and development | — | 8 | °C |
| Tₒ | Optimum temperature for maize growth and development | — | 34 | °C |
| Tₘ | Maximum temperature for maize growth and development | — | 44 | °C |
| GDD | Growing degree-days | — | 6 | °C·d·cm⁻¹ |
| P1 | GDD at stage S2 | 5-450 | 352 | °C·d |
| P20 | Critical day length of maize | — | 12.5 | h |
| P2 | Hourly increase in the number of days when the sunshine hours exceed the critical daylength | 0-2 | 0.796 | d·h⁻¹ |
| DJTI | GDD at stage S3 | — | 4 | d |
| PHINT | Leaf emergence interval | — | 75 | °C·d |
| DSGFT | GDD at stage S5 | — | 170 | °C·d |
| P5 | GDD at stage S6 | 580-999 | 600 | °C·d |

Two-dimensional maize canopy structure simulation model

### Dynamic Simulation of Internode Growth in Maize

Research shows that the elongation of the internodes of maize is a process from slow to fast to slow along with the change of GDD, the internodes grow in an upward elongation way from the morphological lower end, and the growth has certain sequentiality and overlapping property; the thickness of each internode of maize gradually increases along with the growth of maize. Thus, the process of internode elongation and thickening in maize can be quantitatively described by equations (13, 14):

$$I N L {e}_{n} ( G D D ) = \frac{I N L {e}_{n}}{{\left[1 + I N {P}_{a} {e}^{- {s}_{1} \times ( G D D - I N G D {D}_{n} )}\right]}^{{m}_{1}}}$$

$$I N W {e}_{n} ( G D D ) = \frac{I N W {e}_{n}}{{\left[1 + I N {P}_{b} {e}^{- {s}_{2} \times ( G D D - I N G D {D}_{n} )}\right]}^{{m}_{2}}}$$

$$I N G D {D}_{n} = B U M D T T + ( n - 1 ) \times P H I N T$$

$$I N L {e}_{n} = {a}_{1} {n}^{2} + {b}_{1} n + {c}_{1}$$

$$I N W {e}_{n} = {a}_{2} {n}^{2} + {b}_{2} n + {c}_{2}$$

wherein INLeₙ (GDD) and INWeₙ (GDD) are the length (cm) and width (cm) of the n^{th} internode at the time of GDD, respectively; INGDDₙ is GDD of the n^{th} internode which begins to elongate and thicken, and INPₐ and INP_{b} are crop genetic parameters and are used for calibrating the model; s₁, s₂, m₁ and m₂ are model parameters and are used for calibrating the model and are related to the characteristics of the variety; BUMDTT is GDD of maize at the jointing stage; a₁, b₁ and c₁ are model parameters obtained when a potential maximum value is taken as the internode lengthand are related to the characteristics of the variety; a₂, b₂ and c₂ are model parameters obtained when a potential maximum value is taken as the internode width and are related to the characteristics of the variety.

### Dynamic Simulation of Leaf Sheath Growth in Maize

The elongation process of the leaf sheath of maize is a process from slow to fast to slow, and the growth curve of the leaf sheath is an S-shaped growth curve. Therefore, the present study adopts Logistic equations (18, 19) to describe the maize leaf sheath growth process:

$$L S L {e}_{n} \left(G D D\right) = \frac{L S L {e}_{n}}{{\left[1 + L S {P}_{a} \times {e}^{- {S}_{3} \times \left(G D D - L S G D {D}_{n}\right)}\right]}^{{m}_{3}}}$$

$$L S W {e}_{n} \left(G D D\right) = \frac{L S W {e}_{n}}{{\left[1 + L S {P}_{b} \times {e}^{- {S}_{4} \times \left(G D D - L S G D {D}_{n}\right)}\right]}^{{m}_{4}}}$$

$$L S G D {D}_{n} = G D {D}_{1} + \left(n - 1\right) \times P H I N T$$

$$L S L {e}_{n} = {a}_{3} {n}^{2} + {b}_{3} n + {c}_{3}$$

$$L S W {e}_{n} = {a}_{4} {n}^{2} + {b}_{4} n + {c}_{4}$$

wherein LSLeₙ (GDD) and LSWeₙ (GDD) are the length (cm) and width (mm) of the n^{th} leaf sheath at the time of GDD, respectively; LSLeₙ and LSWeₙ are potential maximum values (cm) of the length and width of the n^{th} leaf sheath, respectively; LSGDDₙ is the initial GDD when the n^{th} leaf sheath begins to elongate or thicken; GDD₁ is GDD required by maize from sowing to seedling emergence, and LSPₐ and LSP_{b} are crop genetic parameters and are used for calibrating the model; s₃, s₄, m₃ and m₄ are model parameters and are used for calibrating the model and are related to the characteristics of the variety; a₃, b₃ and c₃ are model parameters obtained when a potential maximum value is taken as the length of the leaf sheath and are related to the characteristics of the variety; a₄, b₄ and c₄ are model parameters obtained when a potential maximum value is taken as the width of the leaf sheath and are related to the characteristics of the variety.

### Dynamic Simulation of Leaf Blade Growth in Maize

The elongation process of the leaf blade of maize is a process from slow to fast along with the change of GDD, the growth curve of the leaf blade is an S-shaped increase, namely, a Logistic equation, so that the elongation process of the leaf blade of maize can be quantitatively described by equations (23 and 24):

$$L E L {e}_{n} \left(G D D\right) = \frac{L E L {e}_{n}}{{\left[1 + L E {P}_{a} \times {e}^{- {S}_{5} \times \left(G D D - L E G D {D}_{n}\right)}\right]}^{{m}_{5}}}$$

$$L E W {e}_{n} \left(G D D\right) = \frac{L E W {e}_{n}}{{\left[1 + L E {P}_{b} \times {e}^{- {S}_{6} \times \left(G D D - L E G D {D}_{n}\right)}\right]}^{{m}_{6}}}$$

$$L E G D {D}_{n} = G D {D}_{1} + \left(n - 1\right) \times P H I N T$$

$$L E L {e}_{n} = {a}_{5} {n}^{2} + {b}_{5} n + {c}_{5}$$

$$L E W {e}_{n} = {a}_{6} {n}^{2} + {b}_{6} n + {c}_{6}$$

wherein LELeₙ (GDD) and LEWeₙ (GDD) are the length (cm) and width (mm) of the n^{th} leaf sheath at the time of GDD, respectively; LEGDDₙ is the initial GDD when the n^{th} leaf sheath begins to elongate or thicken; GDD₁ is GDD required by maize from sowing to seedling emergence, and LEPₐ and LEP_{b} are crop genetic parameters and are used for calibrating the model; s₅, s₆, m₅ and m₆ are model parameters and are used for calibrating the model and are related to the characteristics of the variety; a₅, b₅ and c₅ are model parameters obtained when a potential maximum value is taken as the length of the leaf blade and are related to the characteristics of the variety; a₆, b₆ and c₆ are model parameters obtained when a potential maximum value is taken as the width of the leaf blade and are related to the characteristics of the variety.

### Dynamic Simulation of Tassel Growth in Maize

The maize tassel begins to grow after the maize enters into the jointing stage, the length of the tassel is mainly the elongation of the internode below the tassel, and the elongation and the thickening of the maize tassel can be quantitatively described by equations (28, 29):

$$T A L {e}_{n} \left(G D D\right) = \frac{T A L {e}_{max}}{{\left[1 + T {A}_{B} \times {e}^{- T A {P}_{a} \times \left(G D D - T A G D {D}_{n}\right)}\right]}^{{m}_{7}}}$$

$$T A W {e}_{n} \left(G D D\right) = \frac{T A W {e}_{max}}{{\left[1 + T {A}_{E} \times {e}^{- T A {P}_{b} \times \left(G D D - T A G D {D}_{n}\right)}\right]}^{{m}_{8}}}$$

wherein TALeₙ (GDD) and TAWeₙ (GDD) are the length (cm) and width (mm) of tassel at the time of GDD, respectively; TALeₘₐₓ and TAWeₘₐₓ are the potential length and potential width of the maize tassel, respectively; TAGDDₙ is the initial GDD when the tassel begins to elongate or thicken; TA_{B} is the GDD required by the growth of the maize tassel, and TAPₐ and TAP_{b} are crop genetic parameters and are used for calibrating the model; m₇ and m₈ are model parameters obtained when potential maximum values are taken as the length and width of the tassel, respectively and are related to the characteristics of the variety.

### Dynamic Simulation of Silking Growth in Maize

The growth of the maize silking is slightly slower than that of the tassel, and when the heading stage ends, the silking growth is rapid, and the elongation and thickening of the maize silking can be quantitatively described by equations (30, 31):

$$S L {e}_{n} \left(G D D\right) = \frac{S L {e}_{max}}{{\left[1 + {S}_{B} \times {e}^{- S {P}_{a} \times \left(G D D - S G D {D}_{n}\right)}\right]}^{{m}_{9}}}$$

$$S W {e}_{n} \left(G D D\right) = \frac{S W {e}_{n}}{{\left[1 + {S}_{E} \times {e}^{- S {P}_{b} \times \left(G D D - S G D {D}_{n}\right)}\right]}^{{m}_{10}}}$$

wherein SLeₙ (GDD) and SWeₙ (GDD) are the length (cm) and width (mm) of the silking at the time of GDD, respectively; SLeₘₐₓ and SWeₘₐₓ are the potential length and the potential width of the maize silking, respectively; SGDDₙ is the initial GDD when the silking begins to elongate or thicken; S_{B} is the GDD required by the growth of the maize silking, and Spaₐ and SP_{b} are crop genetic parameters and are used for calibrating the model; m₉ and m₁₀ are model parameters and are related to the characteristics of the variety.

### Dynamic Simulation Model of the Three-Dimensional Spatial Structure of Maize

In the process of describing the three-dimensional spatial structure of maize, the spatial variation characteristics of each organ of the maize need to be described, such as the spatial orientation of veins, the characteristics of leaf margins, the characteristics of leaf shape growth, the morphology of leaf sheath, leaf azimuth angle and the like.

### Simulation of Veins

The veins run through the vascular bundles and other tissue leaf blades in the mesophyll to play the roles of conduction and support, and extend from the petiole to the main veins in the leaf blades. The veins directly determine the spatial orientation of leaf blades, and the spatial orientation of the veins is often described by means of “oblique ejection track” in research. Assuming that the vein curve is in a two-dimensional plane, then the motion track equation of the growth point of the vein curve can be deduced from the oblique ejection motion law as follows:

$$\left[\begin{matrix}x \left(i\right) \\ y \left(i\right)\end{matrix}\right] = \left[\begin{matrix}\sqrt{2 g h} cos \left(α\right) & 0 \\ \sqrt{2 \text{gh}} & g / 2\end{matrix}\right] \left[\begin{matrix}i \\ {i}^{2}\end{matrix}\right]$$

wherein i is any point of the growth time sequence of the veins (0 ≤ i ≤ N), and N is the total time of the “oblique ejection track” motion of the veins and is determined by the length of the veins. g is the gravitational acceleration, α is the initial inclination of the leaf blades, and h is the vertical maximum height of the veins. The vein curve is determined by the parameters a and h, and the values of a and h are determined by the growth time of the veins and change along with the change of the growth time of the veins.

### Simulation of Leaf Margins

The leaf margin of the leaf blade of maize consists of an unfolding part and a folding part of a leaf blade. As the leaf blades unfold, the leaf margins gradually appear wavy folds, while the leaf margins of the folding part are closed, which can be approximately seen as a curled conical surface.

### Construction of a Model of Leaf Margin Unfolding Part

Assuming that the coordinates of point P are (Xₚ, Yₚ, Zₚ), d= O̅P̅, and 1= S̅P̅, then the spatial coordinates (Xₖ, Yₖ, Zₖ) of any point on the leaf margin can be obtained according to the geometric relationship, that is,

$$\left[\begin{matrix}{x}_{s} \\ {y}_{s} \\ {z}_{s}\end{matrix}\right] = \left[\begin{matrix}\left({d}^{2} - {y}_{p}^{2}\right) / {x}_{p} & {y}_{p} / d \\ {y}_{p} & - {x}_{p} / d \\ 0 & {tan}^{- 1} \left(θ\right)\end{matrix}\right] \left[\begin{matrix}1 \\ l ⋅ sin \left(θ\right)\end{matrix}\right]$$

wherein θ is the relative positions of point S, point P and each plane, and I is the leaf width of point S at point P on the vein.

### Construction of a Model of Leaf Margin Folding Part

The folding part of the leaf margin may be approximately a curled conical surface, the cross-section of which is a spiral. α is the polar angle of the spiral, r is the minimum radius vector, R is the maximum radius vector, and P (Xₚ, Yₚ, Zₚ) is the center of the spiral. Assuming that the radius vector of the spiral is in linear relation with the polar angle, the spiral is divided into n segments according to angle, so as to form a sequence {Pi} of n +1 points, and if Pi (xᵢ, yᵢ, zᵢ) exists, then the following relation exists:

$$\left\{\begin{matrix}{x}_{i} = {X}_{p} - \left[r + i ⋅ \left(R - r\right) / n\right] ⋅ cos \left[\left(360 - α\right) / 2 + i ⋅ α / n\right] \\ {y}_{i} = {Y}_{p} \\ {z}_{i} = {Z}_{p} - \left[r + i ⋅ \left(R - r\right) / n\right] ⋅ sin \left[\left(360 - α\right) / 2 + i ⋅ α / n\right]\end{matrix}\right)$$

The point corresponding to the polar angle α/2 on the spiral is superposed with the vein, then the spiral is attached to the vein; the point on the vein is taken as the point corresponding to the polar angle α/2 on the spiral, and the point on each spiral is respectively solved by combining the relationship between the radius vector and the center of the spiral and by using the above-mentioned formula, so that the folding leaf blades can be obtained.

### Dynamic Simulation of Leaf Blade Length and Leaf Arrangement of Unfolding Leaves of Maize

Research shows that the leaf blade length of maize has a significant correlation with leaf arrangement, and the maize changes in a “V” shape from the plant base to the top of the canopy.

Usually, the number of leaf blades of maize plants is determined by genetic characteristics and is related to crop varieties, and the length of leaf blades of most maize varieties is longer in the middle and shorter in both sides. The simulation of leaf blade length can be expressed by the following formula:

$$M L D L \left(N\right) = L D {L}_{M} ⋅ e {}^{\left[L D {L}_{a} {\left(N / {N}_{L D L M} - 1\right)}^{2} + L D {L}_{b} {\left(N / {N}_{L D L M} - 1\right)}^{3}\right]}$$

wherein LDL_{M} is the maximum length of a single leaf, and N_{LDLM} is the leaf arrangement of the longest leaf blade of maize. LDLₐ and LDL_{b} are model parameters and are determined by genetic characteristics.

### Dynamic Simulation of Leaf Blade Width and Leaf Arrangement of Unfolding Leaves of Maize

The variation laws in the width and length of leaf blades of maize are similar, i.e., the leaf blade is wider in the middle and slightly narrower in the upper and lower parts. The simulation of leaf blade width and leaf arrangement can be expressed by the following formula:

$$M L D W \left(N\right) = L D {W}_{M} ⋅ e {}^{\left[L D {W}_{a} {\left(N / {N}_{L D W M} - 1\right)}^{2} + L D {W}_{b} {\left(N / {N}_{L D W M} - 1\right)}^{3}\right]}$$

wherein LDW_{M} is the maximum width of a single leaf, and N_{LDWM} is the leaf arrangement of the widest leaf blade of maize. LDWₐ and LDW_{b} are model parameters and are determined by genetic characteristics.

### Dynamic Simulation of Leaf Shape Relation of Unfolding Leaves of Maize

The leaf shape of maize is a dynamic change process from the beginning of leaf blade growth to the unfolding and shaping of the leaves, and is determined by the change of leaf width in the elongation direction. Therefore, a functional relationship between leaf width and leaf length is constructed to simulate the change in leaf shape:

$$\frac{l w}{L D W} = {n}_{1} ⋅ {\left(\frac{l l}{L D L}\right)}^{2} + {n}_{2} ⋅ \frac{l l}{L D L} + {n}_{3}$$

wherein LDL is the length of a leaf blade, LDW is the maximum width of a leaf blade, lw is the width of a leaf at the length ll, and n₁, n₂ and n₃ are model parameters and are related to crop varieties.

### Dynamic Simulation of Leaf Sheath Length and Leaf Arrangement of Unfolding Leaves of Maize

The leaf sheaths of maize are wrapped on the outer sides of the internodes, playing the roles of supporting the leaf blades, enhancing the plant stalks, and meanwhile, achieving the lodging resistance effect. Research shows that the length of the leaf sheath gradually increases with the elevation of the leaf position, while it begins to shorten at ear-leaf. The relationship between the leaf sheath length and leaf arrangement of unfolding leaves of maize can be expressed by the following formula:

$$M L S L \left(N\right) = \left\{\begin{matrix}L S {L}_{M} \times {e}^{\left[L S {L}_{a l} {\left(N / {N}_{L S L M} - 1\right)}^{2} + L S {L}_{b l} {\left(N / {N}_{L S L M} - 1\right)}^{3}\right]} l \leq N \leq {N}_{i} \\ L S {L}_{n 4} + L S {L}_{n 5} \times N + L S {L}_{n 6} \times {N}^{2} {N}_{i} \leq N \leq L N\end{matrix}\right)$$

wherein LN is the total number of leaves, LSL_{M} is the maximum length of a leaf sheath between 1 to Nᵢ of the leaf arrangement, N_{LSLM} is the leaf arrangement of the longest leaf sheath between 1 to Nᵢ of the leaf arrangement, and n₄, n₅ and n₆ are model parameters and are related to crop varieties.

### Dynamic Simulation of Elongated Internode Length and Leaf Arrangement of Maize

Internode elongation in maize is usually in the form of a slow-fast-slow law, with a regular sequence of internode elongation, the lower part of the plant elongating first and then growing gradually. The relationship between the length of the elongated internode and the leaf arrangement of maize can be expressed by the following formula:

$$M I N L \left(N\right) = \left\{\begin{matrix}I N {L}_{M} \times {e}^{\left[I N {L}_{a l} {\left(N / {N}_{I N L M} - 1\right)}^{2} + L S {L}_{b l} {\left(N / {N}_{I N L M} - 1\right)}^{3}\right]} l \leq N \leq {N}_{i} \\ I N {L}_{n 7} + I N {L}_{n 8} \times N + I N {L}_{n 9} \times {N}^{2} {N}_{i} \leq N \leq L N\end{matrix}\right)$$

wherein LN is the total number of leaves, INL_{M} is the maximum length of a leaf sheath between 1 to Nᵢ of the leaf arrangement, N_{INLM} is the leaf arrangement of the longest leaf sheath between 1 to Nᵢ of the leaf arrangement, and n₇, n₈ and n₉ are model parameters and are related to crop varieties.

### Dynamic Simulation Framework Diagram of a Three-Dimensional Spatial Crop Structure

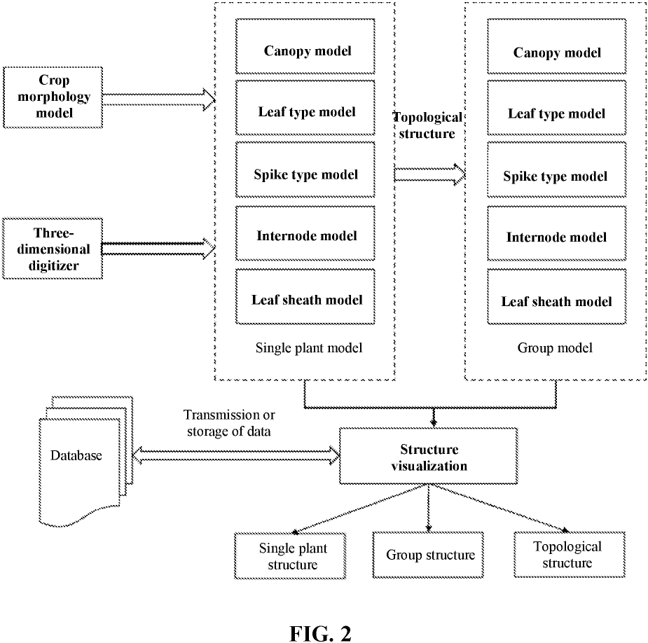

On the basis of quantifying a three-dimensional spatial structure of a single plant, a deduction method for crop leaf blades to a single plant canopy and then to a spatial canopy structure of a crop group is systematically constructed, the existing data are combined to construct a database, topological expansion of the spatial structure is realized, and meanwhile, a time dimension is integrated, and a crop water-carbon flux multi-spatial-temporal cooperative coupling quantitative characterization method is constructed. The specific implementation process is shown in FIG. 2 according to the research content.

In the present embodiment, also included is a dynamic crop growth model construction system for a three-dimensional canopy structure, comprising:
a crop parameter acquisition module, used for acquiring crop parameters;
a two-dimensional crop canopy structure model establishment module, used for establishing a two-dimensional crop canopy structure simulation model according to the crop parameters; and
a three-dimensional dynamic crop growth simulation construction module, used for constructing a three-dimensional dynamic crop growth simulation model by fusing the two-dimensional crop canopy structure model.

The system further comprises a dynamic model establishment module of a water-carbon process of a soil-crop-atmospheric system used for establishing a dynamic model of a water-carbon process of a soil-crop-atmospheric system according to the three-dimensional dynamic crop growth model.

Provided is a computer storage medium having a computer program stored thereon, wherein the computer program, when being executed by a processor, implements the steps of the dynamic crop growth model construction method for a three-dimensional canopy structure.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to accord with the broadest scope consistent with the principles and novel features disclosed herein.

1. A dynamic crop growth model construction method for a three-dimensional canopy structure, comprising the following steps:
1) acquiring crop parameters;
2) establishing a two-dimensional crop canopy structure simulation model according to the crop parameters; and
3) constructing a three-dimensional dynamic crop growth simulation model by utilizing the two-dimensional crop canopy structure simulation model and spatial change characteristics of each organ of crops.

2. The dynamic crop growth model construction method according to claim 1, further comprising:
4) establishing a dynamic model of a water-carbon process of a soil-crop-atmospheric system according to the three-dimensional dynamic crop growth simulation model, comprising:
on a basis of quantifying a three-dimensional dynamic single-plant growth simulation model, constructing a deduction method for crop leaf blades to a single plant canopy and then to a spatial canopy structure of a crop group, constructing a database based on data, realizing topological expansion of the spatial structure, and meanwhile, integrating a time dimension, and constructing a crop water-carbon flux multi-spatial-temporal cooperative coupling quantitative characterization method.

3. The dynamic crop growth model construction method according to claim 1,
wherein the crop parameters comprise canopy structure characteristics and variation laws in crop development processes,
wherein the canopy structure characteristics comprise: a canopy type, a leaf type, a spike type, an internode, and a leaf sheath.

4. The dynamic crop growth model construction method according to claim 1, wherein the two-dimensional canopy structure simulation model describes crop growth and development stages by adopting growing degree-days, and carries out dynamic simulation on a two-dimensional crop canopy structure by adopting a Logistic equation.

5. The dynamic crop growth model construction method according to claim 1, wherein step 3 comprises the following steps: on the basis of the two-dimensional crop canopy structure simulation model, characterizing veins and leaf margins by adopting a spatial topological structure, and constructing the three-dimensional dynamic crop growth simulation model.

6. A dynamic crop growth model construction system for a three-dimensional canopy structure, comprising:
a crop parameter acquisition module, used for acquiring crop parameters;
a two-dimensional crop canopy structure model establishment module, used for establishing a two-dimensional crop canopy structure simulation model according to the crop parameters; and
a three-dimensional dynamic crop growth simulation construction module, used for constructing a three-dimensional dynamic crop growth simulation model by fusing the two-dimensional crop canopy structure simulation model.

7. The dynamic crop growth model construction system according to claim 6, further comprising a dynamic model establishment module of a water-carbon process of a soil-crop-atmospheric system, used for establishing a dynamic model of the water-carbon process of the soil-crop-atmospheric system according to the three-dimensional dynamic crop growth simulation model.

8. A computer storage medium, having a computer program stored thereon, wherein the computer program, when being executed by a processor, implements the steps of the dynamic crop growth model construction method for the three-dimensional canopy structure according to claim 1.

9. The computer storage medium according to claim 8, wherein the dynamic crop growth model construction method further comprises:
4) establishing a dynamic model of a water-carbon process of a soil-crop-atmospheric system according to the three-dimensional dynamic crop growth simulation model, comprising:
on a basis of quantifying a three-dimensional dynamic single-plant growth simulation model, constructing a deduction method for crop leaf blades to a single plant canopy and then to a spatial canopy structure of a crop group, constructing a database based on data, realizing topological expansion of the spatial structure, and meanwhile, integrating a time dimension, and constructing a crop water-carbon flux multi-spatial-temporal cooperative coupling quantitative characterization method.

10. The computer storage medium according to claim 8,
wherein the crop parameters comprise canopy structure characteristics and variation laws in crop development processes,
wherein the canopy structure characteristics comprise: a canopy type, a leaf type, a spike type, an internode, and a leaf sheath.

11. The computer storage medium according to claim 8, wherein the two-dimensional canopy structure simulation model describes crop growth and development stages by adopting growing degree-days, and carries out dynamic simulation on a two-dimensional crop canopy structure by adopting a Logistic equation.

12. The computer storage medium according to claim 8, wherein step 3 comprises the following steps: on the basis of the two-dimensional crop canopy structure simulation model, characterizing veins and leaf margins by adopting a spatial topological structure, and constructing the three-dimensional dynamic crop growth simulation model.
